(19) United States
(12) Patent Application Publication
(10) Pub. No.: US 2022/0122018 A1
(43) Pub. Date: Apr. 21, 2022

(54) INFORMATION VISUALIZATION APPARATUS, INFORMATION VISUALIZATION METHOD, AND COMPUTER-READABLE RECORDING MEDIUM

(71) Applicant: NEC Corporation, Minato-ku, Tokyo (JP)

(72) Inventors: Kei SHIBUYA, Tokyo (JP); Kan ARAI, Tokyo (JP); Makiko AKIGUCHI, Tokyo (JP)

(73) Assignee: NEC Corporation, Minato-ku, Tokyo (JP)

(21) Appl. No.: 17/427,998

(22) PCT Filed: Dec. 25, 2019
(86) PCT No.: PCT/JP2019/050917

§ 371 Date: Aug. 3, 2021

(30) Foreign Application Priority Data
Feb. 6, 2019 (JP) 2019-020142

(51) Int. Cl. G06Q 10/06; G06Q 10/10; G06F 16/26

(52) U.S. Cl. CPC G06Q 10/06398; G06F 16/26; G06Q 10/105

(57) ABSTRACT

An information visualization apparatus 10 includes: a data obtainment unit 11 that obtains, as data, at least one of a response to a questionnaire administered to individuals belonging to an organization, and biometric information collected from the individuals; a coefficient calculation unit 12 that calculates a coefficient indicating correlation among nodes on the basis of the data obtained, in a causal loop diagram in which pre-registered items are nodes and relationships among the nodes are indicated by arrows; an updating unit 13 that updates the causal loop diagram on the basis of the coefficient calculated; and a presentation unit 14 that presents the causal loop diagram.

### TECHNICAL FIELD

The invention relates to an information visualization apparatus and an information visualization method for visualizing information pertaining to an organization and individuals belonging thereto, and further relates to a computer-readable recording medium in which a program for realizing the apparatus and method is recorded.

### BACKGROUND ART

Recently, in organizational management, there is demand for increasing both the motivation of individuals and the motivation of the organization, which is a collection of the individuals, in order to improve employee productivity. In this regard, HR (Human Resources) tech is also attracting attention. “HR tech” is a term created by combining “HR” and “technology”, and refers to a group of solutions that improve operations in the area of human resources, such as personnel evaluation.

For example, Patent Document 1 discloses a system for implementing such HR tech. The system disclosed in Patent Document 1 first aggregates responses to a questionnaire of a target organization, and then proposes an action plan corresponding to the aggregate results. Then, when one of the proposed action plans is selected, the system disclosed in Patent Document 1 sets the selected action plan as an official action plan, and then manages the progress of the set action plan.

The system disclosed in Patent Document 1 can also generate a graph indicating a level of satisfaction for each of factors affecting motivation (company satisfaction, job satisfaction, supervisor satisfaction, and workplace satisfaction) on the basis of the aggregate results of the questionnaire, and then present the generated graph.

The system disclosed in Patent Document 1 can also compare the aggregate results of the latest questionnaire of the targeted organization with the aggregate results of previous questionnaires of that organization or the aggregate results of previous questionnaires of other organizations, and display the comparison results.

Thus, according to the system disclosed in Patent Document 1, the motivation of the members of an organization in their work can be visualized and quantified. As such, managers can grasp the motivation of individuals and the organization as a whole, making it easier for them to take measures to increase motivation. The system disclosed in Patent Document 1 will conceivably make it easier to improve the motivation of individuals and the motivation of an organization.

### LIST OF RELATED ART DOCUMENTS

### Patent Document

Patent Document 1: Japanese Patent Laid-Open Publication No. 2018-18152

### SUMMARY OF INVENTION

### Problems to be Solved by the Invention

However, with the system disclosed in Patent Document 1, causal relationships among factors that affect motivation are not visualized. The system therefore has a problem in that it is difficult for managers to take effective measures against multiple factors, and in that it is difficult to discover problems arising in individuals or organizations after measures are taken.

An example object of the invention is to provide an information visualization apparatus, an information visualization method, and a computer-readable recording medium that can solve the above problems and can visualize causal relationships among factors that affect motivation in individuals and an organization as a whole.

### Means for Solving the Problems

To achieve the above-described object, an information visualization apparatus according to an example aspect of the invention includes: a data obtainment unit that obtains, as data, at least one of a response to a questionnaire administered to individuals belonging to an organization, or biometric information collected from the individuals; a coefficient calculation unit that calculates a coefficient indicating correlation among nodes on the basis of the data obtained, in a causal loop diagram in which pre-registered items are nodes and relationships among the nodes are indicated by arrows; an updating unit that updates the causal loop diagram on the basis of the coefficient calculated; and a presenting unit that presents the causal loop diagram.

Additionally, to achieve the above-described object, an information visualization method according to an example aspect of the invention includes: (a) a step of obtaining, as data, at least one of a response to a questionnaire administered to individuals belonging to an organization, or biometric information collected from the individuals; (b) a step of calculating a coefficient indicating correlation among nodes on the basis of the data obtained, in a causal loop diagram in which pre-registered items are nodes and relationships among the nodes are indicated by arrows; (c) a step of updating the causal loop diagram on the basis of the coefficient calculated; and (d) a step of presenting the causal loop diagram.

Furthermore, to achieve the above-described object, a computer-readable recording medium according to an example aspect of the invention stores a program including commands causing a computer to execute: (a) a step of obtaining, as data, at least one of a response to a questionnaire administered to individuals belonging to an organization, or biometric information collected from the individuals; (b) a step of calculating a coefficient indicating correlation among nodes on the basis of the data obtained, in a causal loop diagram in which pre-registered items are nodes and relationships among the nodes are indicated by arrows; (c) a step of updating the causal loop diagram on the basis of the coefficient calculated; and (d) a step of presenting the causal loop diagram.

### Advantageous Effects of the Invention

As described above, according to the invention, causal relationships among factors affecting motivation in individuals and an organization as a whole can be visualized.

### BRIEF DESCRIPTION OF THE DRAWINGS

FIG. 1 is a block diagram illustrating the overall configuration of an information visualization apparatus according to a first example embodiment of the invention.

FIG. 2 is a block diagram illustrating the configuration of the information visualization apparatus according to a first example embodiment of the invention in detail.

FIG. 3 is a diagram illustrating an example of a questionnaire conducted in the first example embodiment of the invention.

FIG. 4 is a diagram illustrating an example of personal data stored in a personal data storage unit in the first example embodiment of the invention.

FIG. 5 is a diagram illustrating an example of a causal loop diagram used in the first example embodiment of the invention.

FIG. 6 is a diagram illustrating an example of a causal loop diagram to which correlation coefficients have been added in an example embodiment of the invention.

FIG. 7 is a diagram illustrating an example of a database used to update a causal loop diagram in an example embodiment of the invention.

FIG. 8 is a diagram illustrating an example of time-series variation in personal data presented in the first example embodiment of the invention.

FIG. 9 is a flowchart illustrating operations of the information visualization apparatus according to the first example embodiment of the invention.

FIG. 10 is a block diagram illustrating the configuration of an information visualization apparatus according to a second example embodiment of the invention in detail.

FIG. 11 is a diagram illustrating measure candidate formulation processing performed in the second example embodiment of the invention.

FIG. 12 is a diagram illustrating a balanced loop and a reinforcement loop in a loop structure.

FIG. 13 is a diagram illustrating an example of a vicious reinforcement loop and a virtuous reinforcement loop.

FIG. 14 is a diagram illustrating processing when there are two nodes that act as bottlenecks.

FIG. 15 is a diagram illustrating an example of a measure candidate database.

FIG. 16 is a flowchart illustrating operations of the information visualization apparatus according to the second example embodiment of the invention.

FIG. 17 is a block diagram illustrating an example of a computer that implements the information visualization apparatus according to an example embodiment of the invention.

### EXAMPLE EMBODIMENT

First Example Embodiment

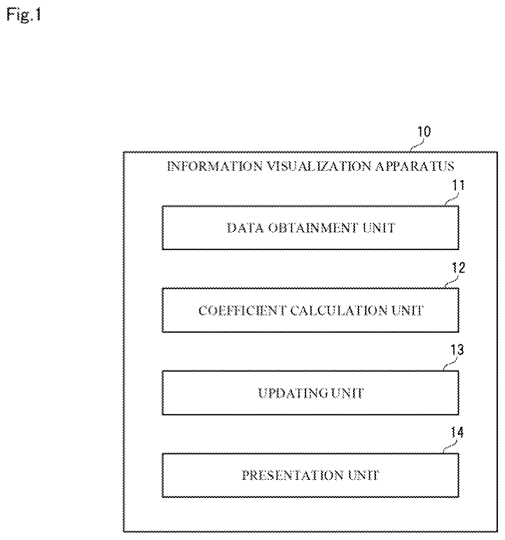

An information visualization apparatus, an information visualization method, and a program according to a first example embodiment of the invention will be described hereinafter with reference to FIGS. 1 to 9.

Apparatus Configuration

First, the configuration of the information visualization apparatus according to the first example embodiment of the invention will be described with reference to FIG. 1. FIG. 1 is a block diagram illustrating the overall configuration of the information visualization apparatus according to the first example embodiment of the invention.

An information visualization apparatus 10 according to the first example embodiment, illustrated in FIG. 1, is an apparatus for visualizing information pertaining to an organization and individuals belonging thereto. As illustrated in FIG. 1, the information visualization apparatus 10 includes a data obtainment unit 11, a coefficient calculation unit 12, an updating unit 13, and a presentation unit 14.

The data obtainment unit 11 obtains, as data, at least one of responses to a questionnaire administered to individuals belonging to an organization, or biometric information collected from the individuals. The coefficient calculation unit 12 calculates coefficients indicating correlation among nodes on the basis of the obtained data, in a causal loop diagram in which pre-registered items are the nodes and relationships among the nodes are indicated by arrows. The updating unit 13 updates the causal loop diagram on the basis of the calculated coefficients. The presentation unit 14 presents the causal loop diagram.

Thus, in the first example embodiment, the causal loop diagram is updated using the data obtained from the individuals, and the updated causal loop diagram is presented. The causal loop diagram is constructed, for example, with factors affecting motivation in the individuals used as nodes. As such, according to the first example embodiment, causal relationships among the factors affecting motivation in the individuals and the organization as a whole can be visualized.

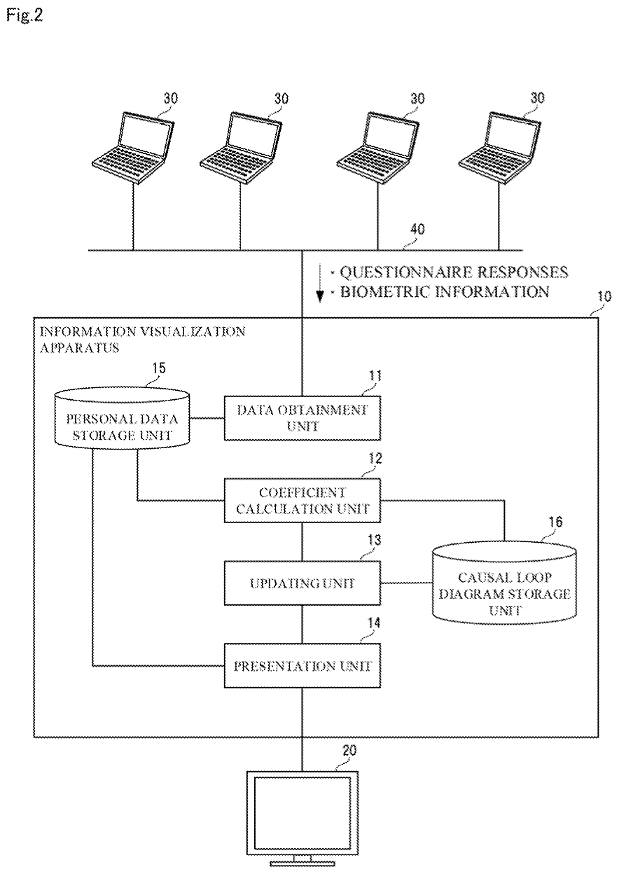

The configuration and functions of the information visualization apparatus 10 according to the first example embodiment will be described in detail next with reference to FIGS. 2 to 7. FIG. 2 is a block diagram illustrating the configuration of the information visualization apparatus according to the first example embodiment of the invention in detail.

As illustrated in FIG. 2, in the first example embodiment, a display device 20 for presenting the causal loop diagram using a screen is connected to the information visualization apparatus 10. In the first example embodiment, the information visualization apparatus 10 is connected to a terminal device 30 of each individual belonging to the organization over a network 40 such as a LAN (Local Area Network).

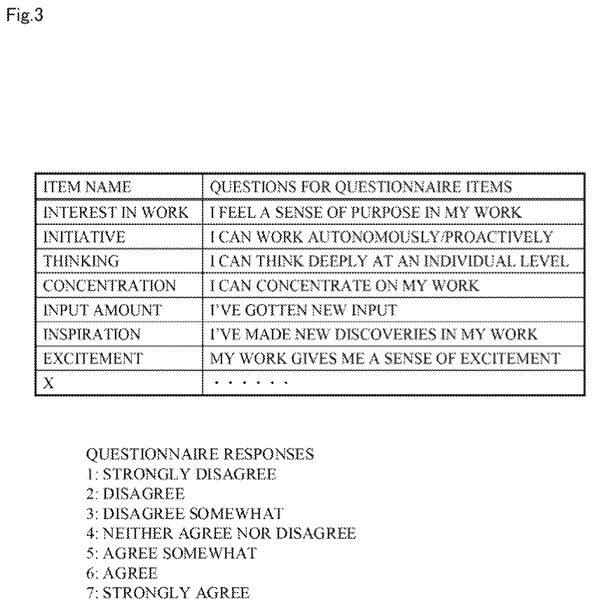

Each individual's terminal device 30 administers the questionnaire illustrated in FIG. 3, for example, on a screen, and receives the input of responses. Each individual's terminal device 30 then sends the input responses to the information visualization apparatus 10 over the network 40. FIG. 3 is a diagram illustrating an example of a questionnaire conducted in the first example embodiment of the invention. In the example in FIG. 3, each individual responds on a seven-point scale, from 1 to 7.

When the individuals are wearing a sensor device for obtaining biometric information, each individual's terminal device 30 obtains the biometric information output by the sensor device, and sends the obtained biometric information to the information visualization apparatus 10 over the network 40 as well. In the first example embodiment, the biometric information includes pulse (heart rate), conversation volume, number of steps, activity status, sleep status, dietary status, UV status, skin temperature, and the like.

As illustrated in FIG. 2, in the first example embodiment, the information visualization apparatus 10 includes a personal data storage unit 15 and a causal loop diagram storage unit 16 in addition to the data obtainment unit 11, the coefficient calculation unit 12, the updating unit 13, and the presentation unit 14. The following will describe a case where a causal loop diagram of the organization as a whole is presented.

In the first example embodiment, the data obtainment unit 11 obtains the questionnaire responses and the biometric information of each individual as data (personal data) from each individual's terminal device 30, which is a PC (Personal Computer), tablet terminal, smartphone, or the like, over a network. In addition, the data obtainment unit 11 stores the obtained personal data in the personal data storage unit 15.

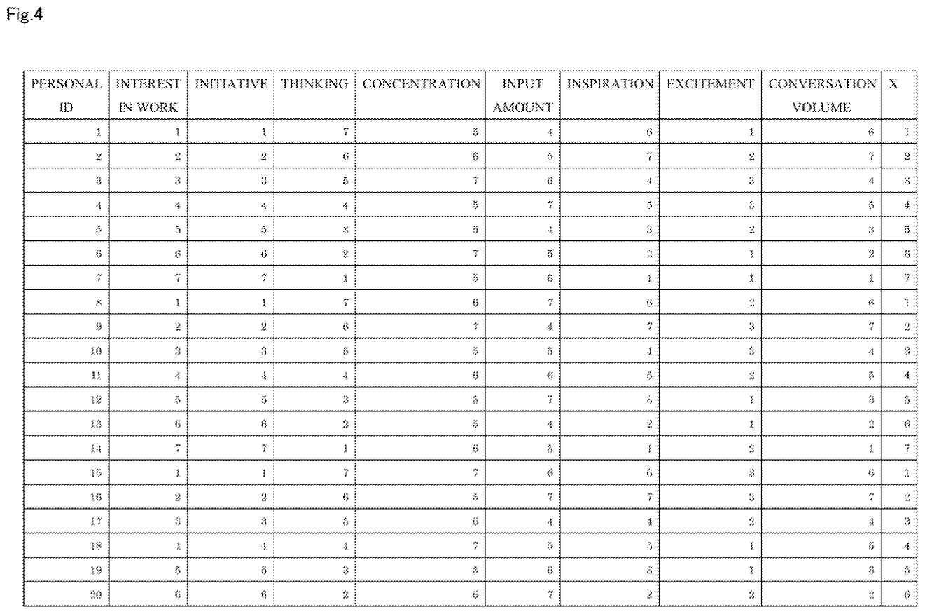

FIG. 4 is a diagram illustrating an example of the personal data stored in the personal data storage unit in the first example embodiment of the invention. In the example in FIG. 4, the personal data storage unit 15 stores the questionnaire responses and biometric information (collectively referred to as “personal data”) for each individual (individual ID (Identification)). As illustrated in FIG. 4, the questionnaire responses include responses for each of the following items: “initiative,” “thinking,” “concentration,” “input amount,” “inspiration,” “excitement,” and “X”. Additionally, as illustrated in FIG. 4, only “conversation volume” is stored as the biometric information. Note that “X” is a desired item.

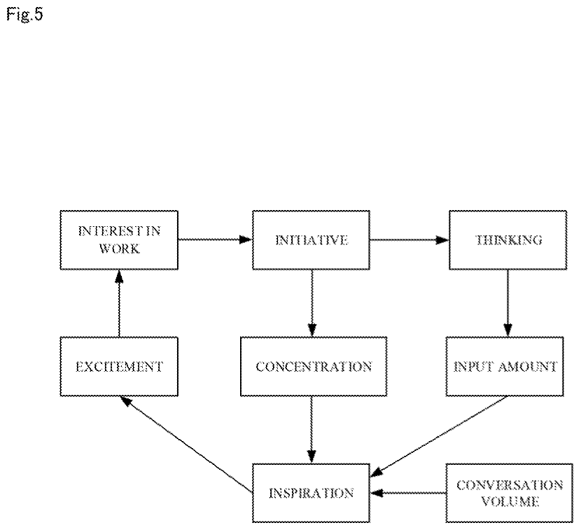

In the first example embodiment, the coefficient calculation unit 12 first obtains the personal data illustrated in FIG. 4 from the personal data storage unit 15, and furthermore obtains the causal loop diagram from the causal loop diagram storage unit 16. The causal loop diagram storage unit 16 stores the causal loop diagram illustrated in FIG. 5, for example. FIG. 5 is a diagram illustrating an example of the causal loop diagram used in the first example embodiment of the invention.

In the example in FIG. 5, items serving as nodes in the causal loop diagram correspond to respective items of the personal data. The arrows indicate relationships between the nodes (between the items). In the following, “arrows” may also be referred to as “arcs”. Furthermore, boosting the item of a specific node is normally pre-set as a goal in a causal loop diagram. In FIG. 5, boosting the node “excitement” is set as a goal.

In the example in FIG. 5, the nodes in the causal loop diagram and the items of the personal data correspond one-to-one as described above, but the present example embodiment is not limited to this example. For example, one node indicated in the causal loop diagram may correspond to a plurality of items of the personal data. For example, if three questions in the questionnaire are prepared for the node “interest in work”, three items correspond to that node.

In the first example embodiment, the coefficient calculation unit 12 can calculate a correlation coefficient, which indicates a relationship between two types of data, as a coefficient indicating a correlation between nodes. Specifically, the coefficient calculation unit 12 can calculate a correlation coefficient r between x and y using Expression 1, below. In the following Expression 1, S_{xy} represents a covariance between x and y, Sₓ represents a standard deviation of x, and S_{y} represents a standard deviation of y. n represents a total number of bivariate data (x,y), and xᵢ and yᵢ represent individual numerical values. x bar and y bar are both average values.

$$r = \frac{{S}_{xy}}{{S}_{x} {S}_{y}} = \frac{\frac{1}{n} {\sum }_{t = 1}^{n} ( {x}_{i} - \overline{x} ) ( {y}_{i} - \overline{y} )}{\sqrt{\frac{1}{n} {\sum }_{i = 1}^{n} {( {x}_{i} - \overline{x} )}^{2}} \sqrt{\frac{1}{n} {\sum }_{i = 1}^{n} {( {y}_{i} - \overline{y} )}^{2}}} \qquad [ Expression 1 ]$$

A case of calculating the correlation coefficient between “interest in work” and “initiative” in the causal loop diagram illustrated in FIG. 5 will be described here. In this case, it is assumed that the required causal loop diagram is of the organization as a whole. Note that in light of the direction of the arrow, the correlation coefficient is denoted as “correlation coefficient for ‘interest in work’→‘initiative’”. The same type of denotation is used for the correlation coefficients between other nodes as well.

The arc is pointing from “interest in work” toward “initiative”, and the coefficient calculation unit 12 therefore calculates the correlation coefficient r using the foregoing Expression 1, with x representing the value of “interest in work” and y representing the value of “initiative”. At this time, the values of “interest in work” for the individuals are x₁ to xᵢ, and the values of “initiative” for the individuals are y₁ to yᵢ. The correlation coefficients are calculated for the other nodes in the same manner. When one node indicated in the causal loop diagram corresponds to a plurality of items of the personal data as described above, the correlation coefficient is calculated using the sum, the average value, a representative value, or the like of the plurality of items, for example.

Additionally, in the first example embodiment, the coefficient is not limited to a correlation coefficient as long as it expresses a correlation between nodes, and a partial correlation coefficient can be given as an example of another coefficient. Partial correlation coefficients can be calculated through an existing mathematical method.

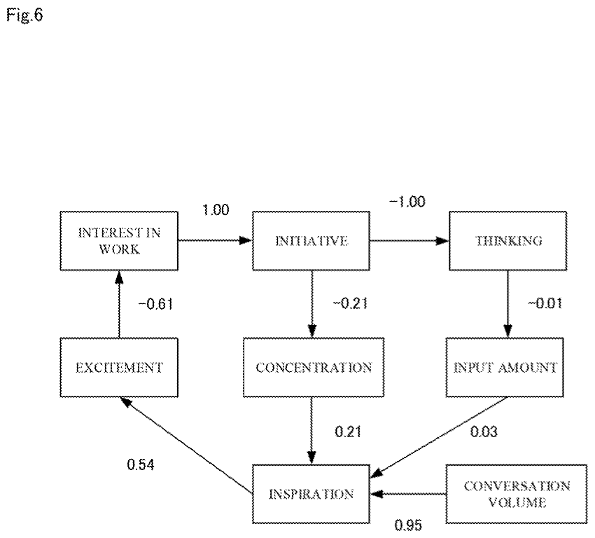

In the first example embodiment, when the coefficient calculation unit 12 calculates the correlation coefficient between the nodes, the updating unit 13 adds the calculated correlation coefficients to the causal loop diagram and updates the diagram, as illustrated in FIG. 6. The updating unit 13 also stores the updated causal loop diagram in the causal loop diagram storage unit 16. FIG. 6 is a diagram illustrating an example of the causal loop diagram to which correlation coefficients have been added in the example embodiment of the invention.

Additionally, when there are nodes between which the value of the correlation coefficient is less than a threshold, the updating unit 13 deletes the arc between those nodes. If there is a node that no longer has any connected arcs due to the deletion, the updating unit 13 deletes that node as well. The updating unit 13 can also update the causal loop diagram by deleting arcs and nodes.

The deletion of nodes and arcs will be described in detail here with reference to FIGS. 4 to 6. The following descriptions assume that “0.5” is set as a threshold when deleting arcs.

As described above, boosting “excitement” is set as a goal in the causal loop diagram illustrated in FIG. 5. As such, the updating unit 13 determines whether or not the correlation coefficients are less than the threshold using “excitement” as a starting point.

Specifically, as illustrated in FIG. 6, there is one arc, from “inspiration”, which reaches “excitement”, and thus the updating unit 13 starts by determining the correlation coefficient of “inspiration→excitement”. As indicated in FIG. 6, the correlation coefficient is 0.54 in this case, and thus the updating unit 13 determines that the correlation coefficient is at least the threshold. Therefore, the updating unit 13 leaves the arc reaching “excitement” from “inspiration”, and does not delete the arc.

Meanwhile, there are three arcs pointing to the node “inspiration”, namely from the nodes “concentration”, “input amount”, and “conversation volume”, respectively. As illustrated in FIG. 6, the correlation coefficient of “conversation volume→inspiration” is 0.95, and thus the updating unit 13 leaves the arc reaching “inspiration” from “conversation volume”. On the other hand, the correlation coefficient of “input amount→inspiration” is 0.03, and the correlation coefficient of “concentration→inspiration” (concentration→inspiration) is 0.21. The updating unit 13 therefore deletes those arcs.

Furthermore, when an arc is deleted, i.e., when there is a node for which a connected arc is deleted, the updating unit 13 first calculates the correlation coefficient between the node for which the connected arrow has been deleted and another node. Then, the updating unit 13 updates the causal loop diagram by using a new arc to connect the node for which the connected arrow has been deleted to the other node on the condition that, in this case, the calculated correlation coefficient is at least the threshold.

Specifically, when deleting the arc reaching “inspiration” from “input amount”, the updating unit 13 makes a determination for another arc reaching the node “input amount”, which was the root of the deleted arc. In the example in FIG. 6, the updating unit 13 makes the determination for the correlation coefficient of “thinking→input amount”. In this case, the correlation coefficient is −0.01, and the absolute value thereof, which is 10.011, is less than the threshold of 0.5, and the updating unit 13 therefore sets the arc reaching “input amount” from “thinking” as a candidate for deletion.

Next, the updating unit 13 calculates the correlation coefficient of “thinking→inspiration” between “thinking” and “inspiration”, where “input amount”, which is a node located between “inspiration” and “thinking”, has been excluded. According to the personal data indicated in FIG. 4, the correlation coefficient is 0.9, and thus the updating unit 13 determines that the calculated correlation coefficient is at least the threshold and creates a new arc reaching “inspiration” from “thinking”.

In this manner, in the first example embodiment, the causal loop diagram is updated by deleting nodes and arcs. The updating unit 13 also deletes the arc reaching “inspiration” from “concentration”, and therefore makes a determination for the correlation coefficient of the arc reaching “concentration” from “initiative” as well. Thereafter, if the correlation coefficient is less than the threshold, the updating unit 13 calculates the correlation coefficient of “initiative→inspiration”, and when that correlation coefficient is at least the threshold, creates a new arc.

Additionally, in the foregoing example, the correlation coefficient determinations are started using a target node of “excitement” as a starting point, and thus the number of calculations is reduced. Assume here that the correlation coefficient determinations are started using “interest in work”, which is the furthest factor from “excitement”, as the starting point. In this case, assuming the correlation coefficient of “inspiration→excitement” is less than the threshold, the causal relationship between “inspiration” and the node which is the root of the arc reaching “inspiration” does not affect “excitement”, which is the final goal, and thus the calculations up to “inspiration” are needless. The same applies even when the correlation coefficients of “interest in work→initiative”, “initiative→concentration”, and “concentration→inspiration” are at least the threshold.

Updating of the causal loop diagram when there is an item which is present in the personal data but absent from the causal loop diagram will be described next with reference to FIGS. 4 to 6. In the example in FIG. 4, the item “X” corresponds to such an item.

Specifically, when, for a specific node, the correlation coefficients of all the arcs coming from that node are less than the threshold, the updating unit 13 sets that node as a candidate for deletion, and also sets a node for the item “X” in the causal loop diagram. Then, the updating unit 13 calculates the correlation coefficient between the specific node which is now a candidate for deletion and the node “X”, and determines whether or not the calculated correlation coefficient is at least the threshold.

For example, assume that in the example in FIG. 6, the correlation coefficient of “conversation volume→inspiration” is less than the threshold of 0.5. In this case, “conversation volume” has no other arcs, and is therefore a candidate for deletion; as such, the updating unit 13 calculates the correlation coefficient of “conversation volume→X”. Then, when the calculated correlation coefficient is at least the threshold of 0.5, the updating unit 13 adds “X” as a node, and also adds an arc reaching “X” from “conversation volume”.

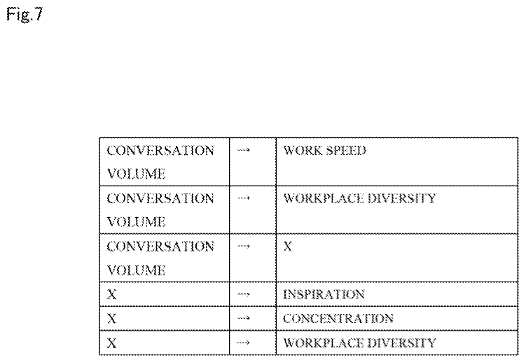

The addition of a node which is not originally present in the causal loop diagram, and the addition of an arc connected to that node, can be performed using the database illustrated in FIG. 7. FIG. 7 is a diagram illustrating an example of a database used to update the causal loop diagram in the example embodiment of the invention. The database illustrated in FIG. 7 is stored in the causal loop diagram storage unit 16, for example.

As illustrated in FIG. 7, for each item, another item which affects the stated item is registered in the database. The registered items are used as nodes in the causal loop diagram illustrated in FIGS. 5 and 6. In FIG. 7, the arrows indicate the directions of the arcs in the causal loop diagram.

Specifically, in the example in FIG. 7, “work speed”, “workplace diversity”, and “X” are registered as items which affect “conversation volume”. “Work speed”, “workplace diversity”, and “X” are items which are initially not present as nodes in the causal loop diagram illustrated in FIG. 5.

Additionally, in the example in FIG. 7, “inspiration”, “concentration”, and “workplace diversity” are registered as items affected by “X”, which initially is not present as a node in the causal loop diagram. Note that although “inspiration” and “concentration” are items which initially are present as nodes in the causal loop diagram illustrated in FIG. 5, “workplace diversity” is an item which initially is not present as a node in the causal loop diagram illustrated in FIG. 5.

Assume, in a situation where such a database exists, that the arc connected to “conversation volume” is deleted and “conversation volume” has become a candidate for deletion, as described above. In this case, the updating unit 13 calculates the correlation coefficients of “conversation volume→work speed”, “conversation volume→workplace diversity”, and “conversation volume→X”, and when any of the calculated correlation coefficients is at least the threshold, deletes the arc from “conversation volume”.

Additionally, “inspiration”, “concentration”, and “workplace diversity” are registered in the database as items affected by “X”. Accordingly, when “X” has been added as a node, the updating unit 13 calculates the correlation coefficients for “X→inspiration”, “X→concentration”, and “X→workplace diversity”. When a correlation coefficient which is at least the threshold is present, the updating unit 13 adds an arc reaching that node from “X”.

In the first example embodiment, the presentation unit 14 presents the causal loop diagram updated by the updating unit 13 by displaying the causal loop diagram in a screen of the display device 20. The presentation unit 14 can also display the causal loop diagram in a screen of a terminal device of a manager instead of the display device 20.

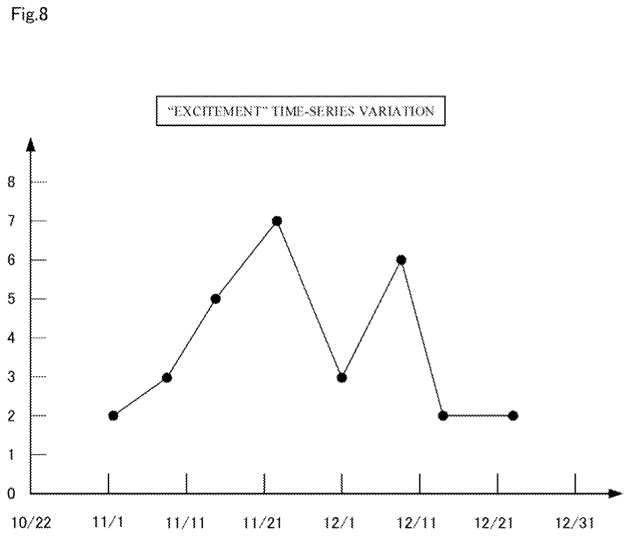

Furthermore, the presentation unit 14 can present the details of the personal data along with the causal loop diagram. Assume that the personal data is obtained a plurality of times during an interval of time, and is stored in the personal data storage unit 15 each time. In this case, as illustrated in FIG. 8, the presentation unit 14 can also present the personal data in time series. FIG. 8 is a diagram illustrating an example of time-series variation in the personal data presented in the first example embodiment of the invention. In the example in FIG. 8, the value of the item “excitement” is presented in time series. During this presentation, the presentation unit 14 can also calculate an average value, a total value, a standard deviation, or the like of the item values and present the calculated value.

Apparatus Operations

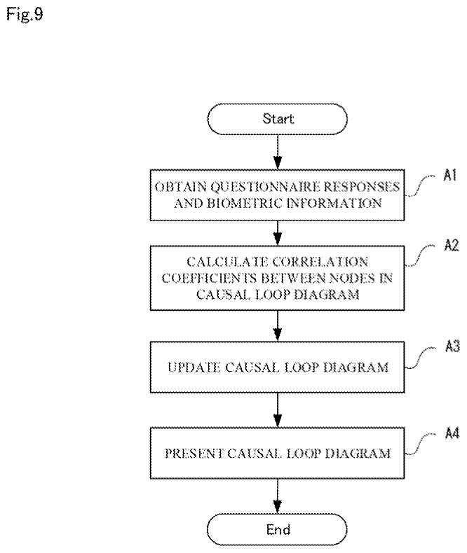

Next, operations of the information visualization apparatus 10 according to the first example embodiment will be described with reference to FIG. 9. FIG. 9 is a flowchart illustrating operations of the information visualization apparatus according to the first example embodiment of the invention. The following descriptions will refer to FIGS. 1 to 7 as appropriate. In the first example embodiment, the information visualization method is realized by causing the information visualization apparatus 10 to operate. As such, the following descriptions of the operations of the information visualization apparatus 10 will be given in place of descriptions of the information visualization method according to the first example embodiment.

As illustrated in FIG. 9, first, the data obtainment unit 11 obtains, as data, responses to a questionnaire administered to individuals belonging to an organization, and biometric information collected from the individuals (step A1).

Specifically, in step A1, the data obtainment unit 11 obtains the questionnaire responses and biometric information of each individual as data (the personal data) from each individual's terminal device 30 over the network, and stores that data in the personal data storage unit 15.

Next, the coefficient calculation unit 12 obtains the personal data from the personal data storage unit 15, obtains the causal loop diagram from the causal loop diagram storage unit 16, and using the personal data and the causal loop diagram, calculates the correlation coefficients between each of the nodes in the causal loop diagram (step A2).

Specifically, in step A2, the coefficient calculation unit 12 calculates the correlation coefficients between each of the nodes by substituting the data of each individual in the foregoing Expression 1.

Next, the updating unit 13 updates the causal loop diagram using the correlation coefficients calculated in step A2 (step A3). As a result, as illustrated in FIG. 6, the correlation coefficients are added to the causal loop diagram illustrated in FIG. 5. Note that the updated causal loop diagram may be a causal loop diagram which has already been updated.

Specifically, in step A3, the updating unit 13 updates the causal loop diagram by deleting nodes and arcs from the causal loop diagram, and furthermore adding nodes and arcs, in addition to adding the correlation coefficients to the causal loop diagram. The updating unit 13 then stores the updated causal loop diagram in the causal loop diagram storage unit 16.

Next, the presentation unit 14 presents the causal loop diagram to a manager of the organization by displaying the updated causal loop diagram in the screen of the display device 20 (step A4).

After step A4 is executed, the processing by the information visualization apparatus 10 ends once. However, in the first example embodiment, steps A1 to A4 are executed again each time a set period of time passes, or each time a set amount of personal data is accumulated, for example. Accordingly, the manager of the organization can confirm the time-series variation of the causal loop diagram.

Variations

Although the foregoing example describes a configuration in which a causal loop diagram for the organization as a whole is displayed, the first example embodiment is not limited to this configuration. The first example embodiment may be a configuration in which a causal loop for each individual belonging to the organization is presented.

In this configuration, the coefficient calculation unit 12 calculates the correlation coefficients between the nodes using the foregoing Expression 1, for example, for each individual. In the case of a causal loop diagram for each individual, data obtained for the individual on different days or at different times is used as x₁ to xᵢ and y₁ to yᵢ. Additionally, in this configuration, the updating unit 13 updates the causal loop diagram for each individual, and the presentation unit 14 presents the causal loop diagram for each individual.

Additionally, the example embodiment may be a configuration in which the coefficient calculation unit 12 calculates the correlation coefficients for each individual and the correlation coefficients for the organization as a whole, and the updating unit 13 presents the causal loop diagrams for each individual and for the organization as a whole. In this case, the presentation unit 14 can present both the causal loop diagram for each individual and the causal loop diagram for the organization as a whole.

### Effects of First Example Embodiment

According to the first example embodiment, the causal loop diagram can be updated on the basis of the personal data, and the latest causal loop diagram can be presented. According to the first example embodiment, causal relationships among the factors affecting motivation in the individuals and the organization as a whole can be visualized.

Program

It suffices for the program according to the first example embodiment to be a program that causes a computer to execute steps A1 to A4 illustrated in FIG. 9. The information visualization apparatus and the information visualization method according to the first example embodiment can be realized by installing the program in a computer and executing the program. In this case, a processor of the computer functions as the data obtainment unit 11, the coefficient calculation unit 12, the updating unit 13, and the presentation unit 14, and performs the processing.

Additionally, in the first example embodiment, the personal data storage unit 15 and the causal loop diagram storage unit 16 can be realized by storing data files corresponding to those units in a storage device, such as a hard disk, provided in the computer.

The program according to the first example embodiment may be executed by a computer system constructed from a plurality of computers. In this case, for example, each computer may function as one of the data obtainment unit 11, the coefficient calculation unit 12, the updating unit 13, and the presentation unit 14. The personal data storage unit 15 and the causal loop diagram storage unit 16 may be constructed in a different computer from the computer which executes the program according to the first example embodiment.

### Second Example Embodiment

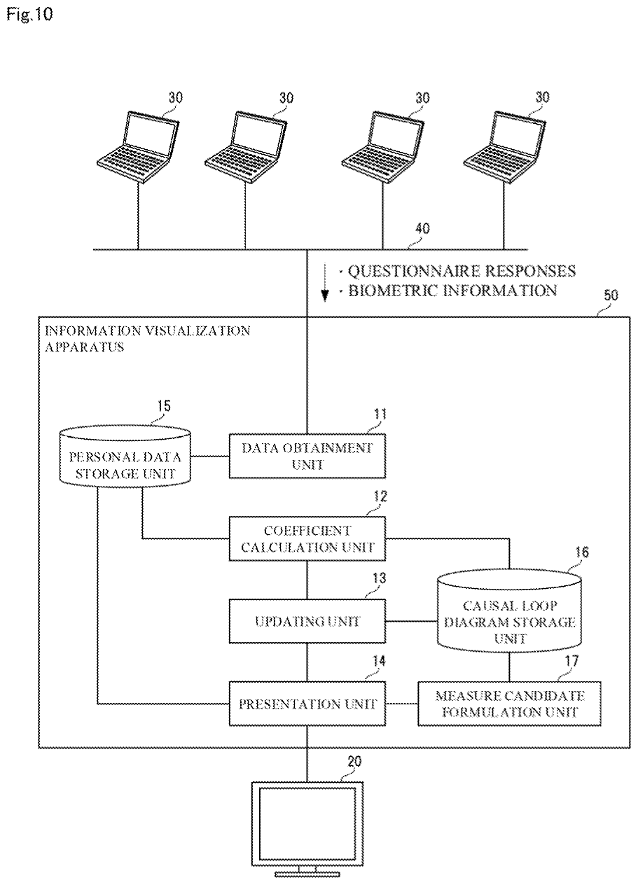

An information visualization apparatus, an information visualization method, and a program according to a second example embodiment of the invention will be described next with reference to FIGS. 10 to 16.

Apparatus Configuration

First, the configuration of the information visualization apparatus according to the second example embodiment of the invention will be described with reference to FIG. 10. FIG. 10 is a block diagram illustrating the configuration of the information visualization apparatus according to the second example embodiment of the invention in detail.

Like the information visualization apparatus 10 according to the first example embodiment, an information visualization apparatus 50 according to the second example embodiment, illustrated in FIG. 10, is an apparatus for visualizing information pertaining to an organization and individuals belonging thereto. As illustrated in FIG. 10, like the information visualization apparatus 10, the information visualization apparatus 50 includes the data obtainment unit 11, the coefficient calculation unit 12, the updating unit 13, the presentation unit 14, the personal data storage unit 15, and the causal loop diagram storage unit 16.

However, in the second example embodiment, the information visualization apparatus 50 includes a measure candidate formulation unit 17 in addition to the aforementioned units. The following will mainly describe the differences from the first example embodiment. When the causal loop diagram is updated, the measure candidate formulation unit 17 specifies a bottleneck for solving an issue in the organization as a whole or an individual, and formulates a measure from the specified bottleneck.

First, when a specific node is designated in advance in the causal loop diagram, the measure candidate formulation unit 17 specifies a loop structure constructed by the designated node, another node, and an arc. Then, on the basis of the correlation coefficient between the nodes in the specified loop structure, the measure candidate formulation unit 17 specifies a node that affects the designated node, and on the basis of the item of the specified node, formulates a candidate for a measure to be taken by the organization.

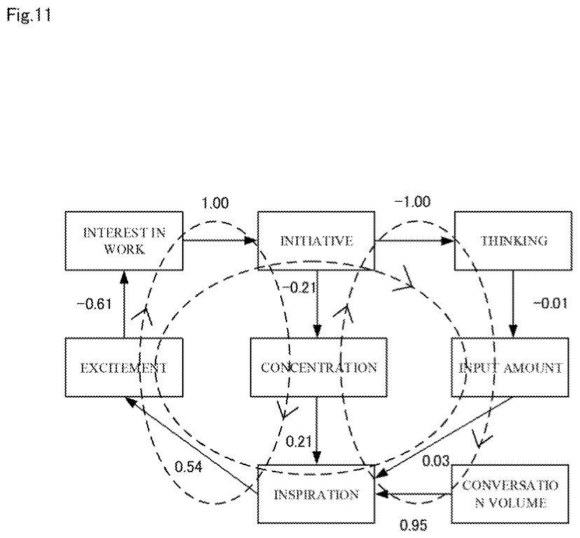

The functions of the measure candidate formulation unit 17 will be described in further detail here, with reference to FIGS. 11 to 15. FIG. 11 is a diagram illustrating measure candidate formulation processing performed in the second example embodiment of the invention. The causal loop diagram illustrated in FIG. 11 is the same as the causal loop diagram illustrated in FIG. 6.

First, the loop structure is a part of the causal loop diagram in which a loop is formed by arcs and nodes by closing the arcs. In the example in FIG. 10, three loop structures are present, as indicated by the broken lines.

In the second example embodiment, boosting “excitement” is set as a goal, and “excitement” is designated. Accordingly, as illustrated in FIG. 10, the measure candidate formulation unit 17 extracts a loop structure including “excitement” from the causal loop diagram. Note that “conversation volume→inspiration” does not form a loop structure.

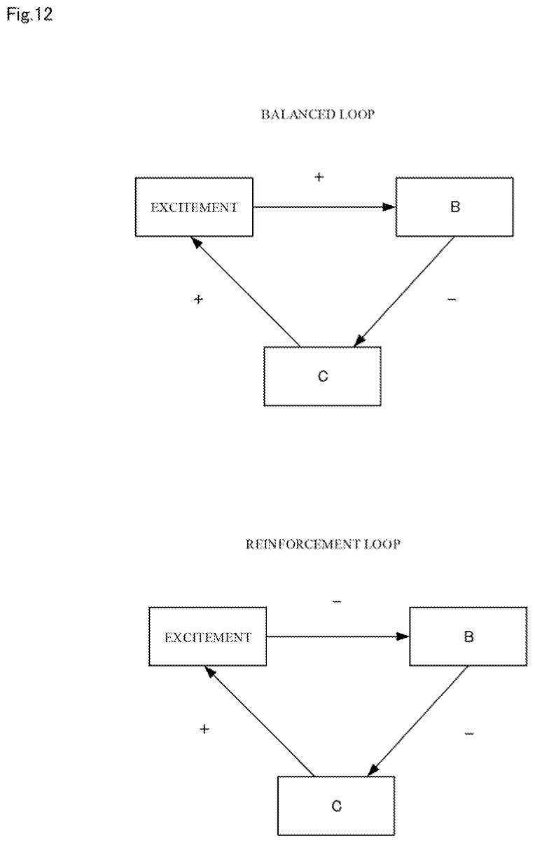

Loop structures include balanced loops and reinforcement loops. Whether a loop is a balanced loop or a reinforcement loop is determined from the sum of the number of positive correlation coefficients and the number of negative correlation coefficients in the loop structure. FIG. 12 is a diagram illustrating a balanced loop and a reinforcement loop in a loop structure. In FIG. 12, the upper part of the drawing illustrates a balanced loop, and the lower part of the drawing illustrates a reinforcement loop. In FIG. 12, “+” indicates that a correlation coefficient is positive, whereas “−” indicates that a correlation coefficient is negative.

As illustrated in FIG. 12, when the sum of the number of positive correlation coefficients and the number of negative correlation coefficients in the loop structure is positive (when the number of arcs having a negative correlation coefficient is even), the loop is a balanced loop. On the other hand, when the sum of the number of positive correlation coefficients and the number of negative correlation coefficients in the loop structure is negative (when the number of arcs having a negative correlation coefficient is odd), the loop is a reinforcement loop.

Additionally, as illustrated in FIG. 12, in a balanced loop, there is a positive relationship in that “B” increases when “excitement” increases and “B” decreases when “excitement” decreases. In a reinforcement loop, there is a negative relationship in that “B” decreases when “excitement” increases and “B” increases when “excitement” decreases.

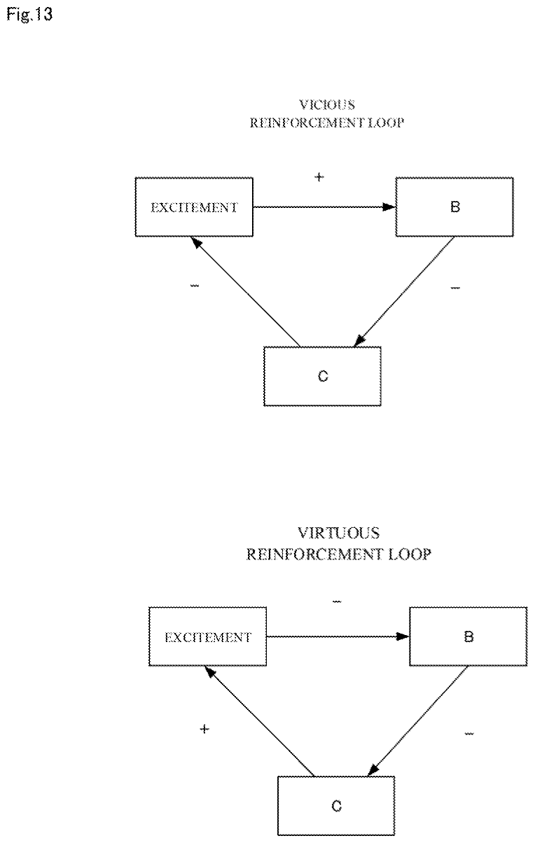

Reinforcement loops include vicious reinforcement loops and virtuous reinforcement loops. FIG. 13 is a diagram illustrating an example of a vicious reinforcement loop and a virtuous reinforcement loop. As illustrated in FIG. 13, when boosting excitement” is a goal, the reinforcement loop is a “vicious reinforcement loop when “excitement” continues to decrease. Conversely, when boosting “excitement” is a goal, the reinforcement loop is a virtuous reinforcement loop when “excitement” continues to increase.

In this manner, whether the reinforcement loop is a vicious cycle or a virtuous cycle is determined according to whether the correlation coefficients of the arcs reaching “excitement” are positive or negative. In other words, when the correlation coefficients of the arcs reaching “excitement”, which is the goal, are negative (−), the loop is determined to be a vicious reinforcement loop. On the other hand, when the correlation coefficients of the arcs reaching “excitement”, which is the goal, are positive (+), the loop is determined to be a virtuous reinforcement loop.

If the loop is known to be a vicious reinforcement loop, the node acting as a bottleneck can be specified. Accordingly, because boosting “excitement” is a goal, in the example in FIG. 11, the measure candidate formulation unit 17 specifies “B”, which is a root factor, as the bottleneck for solving the issue, on the basis of “B→C→excitement”.

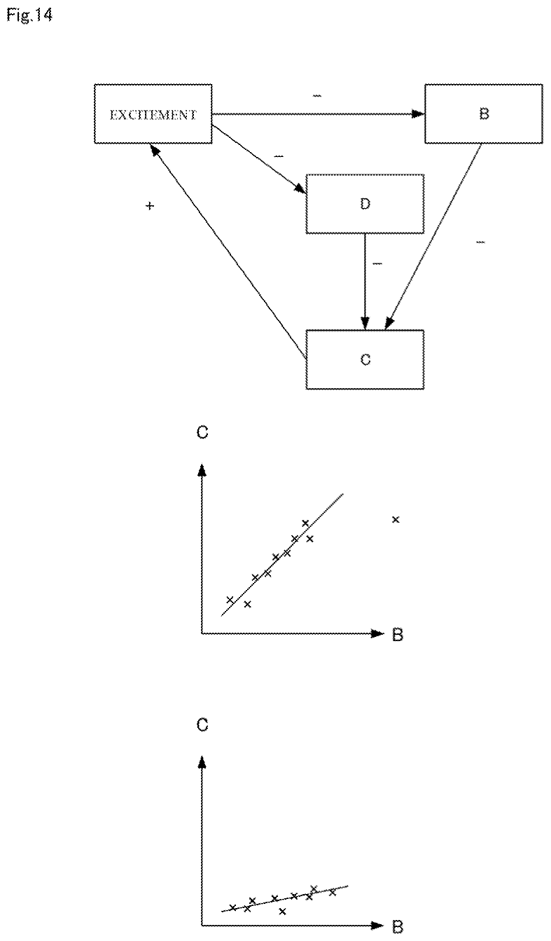

When there are two nodes which may act as bottlenecks, the measure candidate formulation unit 17 calculates a regression coefficient for each node and sets the node having a greater effect as the bottleneck. FIG. 14 is a diagram illustrating processing when there are two nodes that act as bottlenecks. In FIG. 14, the upper part of the drawing illustrates a loop structure when there are two nodes that may act as bottlenecks, and the middle and lower parts of the drawing illustrate the respective regression coefficients of the nodes that may act as bottlenecks.

In the upper part of FIG. 14, two loop structures, both of which are vicious reinforcement loops, are illustrated, namely “excitement→B→C→excitement” and “excitement→D→C→excitement”. In these vicious reinforcement loops, boosting “excitement” is a goal, and nodes “B” and “D” are specified as bottleneck candidates. Accordingly, the measure candidate formulation unit 17 finds a regression coefficient of “B→C” and a regression coefficient of “D→C”, as indicated in the middle and lower parts of FIG. 2, and compares the two. The regression coefficients are found from the data values of the items “B” and “D” in the personal data.

Here, assuming the regression coefficient of “B→C” is α, a regression formula of C=αB+k is found from the middle part of FIG. 14. Likewise, assuming the regression coefficient of “D→C” is β, a regression formula of C=βD+k is found from the lower part of FIG. 14. As can be seen from the middle and lower parts of FIG. 2, α and β are in a relationship in which α>β. It can therefore be seen that the expected increase in the value of “C” when the value of “D” is increased (the effect on C of taking measures for D) is lower than the expected increase in the value of “C” when the value of “B” is increased (the effect on C of taking measures for B). The measure candidate formulation unit 17 therefore specifies “B” as the bottleneck.

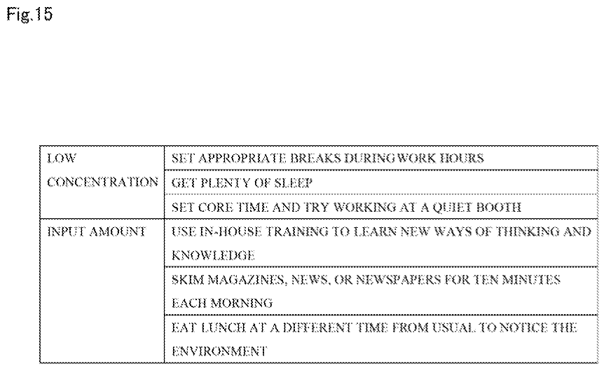

Next, once the node acting as the bottleneck is specified, the measure candidate formulation unit 17 formulates a candidate measure corresponding to the specified node, using a measure candidate database illustrated in FIG. 15. FIG. 15 is a diagram illustrating an example of the measure candidate database. As illustrated in FIG. 15, the measure candidate database registers candidate measures corresponding to nodes acting as bottlenecks. The example in FIG. 15 indicates candidate measures for a case where “low concentration” or “input amount” is specified as the bottleneck.

Additionally, in the second example embodiment, when a candidate measure is formulated by the measure candidate formulation unit 17, the presentation unit 14 presents the formulated candidate measure in addition to the causal loop diagram updated by the updating unit 13. Furthermore, the presentation unit 14 can also present the node that acts as the bottleneck. As in the first example embodiment, the presentation by the presentation unit 14 can be made in the screen of the display device 20, or in the screen of a manager's terminal device.

Apparatus Operations

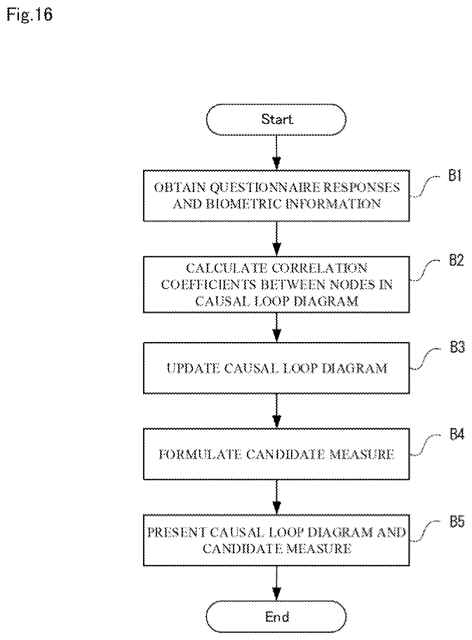

Next, operations of the information visualization apparatus 50 according to the second example embodiment will be described with reference to FIG. 16. FIG. 16 is a flowchart illustrating operations of the information visualization apparatus according to the second example embodiment of the invention. The following descriptions will refer to FIGS. 10 to 15 as appropriate. In the second example embodiment, an information visualization method is realized by causing the information visualization apparatus 50 to operate. As such, the following descriptions of the operations of the information visualization apparatus 50 will be given in place of descriptions of the information visualization method according to the second example embodiment.

As illustrated in FIG. 14, first, the data obtainment unit 11 obtains, as data, at least one of responses to a questionnaire administered to individuals belonging to an organization, and biometric information collected from the individuals (step B1). Step B1 is the same step as step A1 in FIG. 9.

Next, the coefficient calculation unit 12 obtains the personal data from the personal data storage unit 15, obtains the causal loop diagram from the causal loop diagram storage unit 16, and using the personal data and the causal loop diagram, calculates coefficients indicating correlation between each of the nodes in the causal loop diagram (step B2). Step B2 is the same step as step A2 in FIG. 9.

Next, the updating unit 13 updates the causal loop diagram using the correlation coefficients calculated in step B2 (step A3). Step B3 is the same step as step A3 in FIG. 9.

Next, the measure candidate formulation unit 17 specifies a loop structure including the node designated in advance, in the causal loop diagram updated in step A3. Then, on the basis of the correlation coefficient between the nodes in the specified loop structure, the measure candidate formulation unit 17 specifies a node that affects the designated node, and on the basis of the item of the specified node, formulates a candidate for a measure to be taken by the organization (step B4).

Next, by displaying the causal loop diagram updated in step A3 and the candidate measure created in step A4 in the screen of the display device 20, the presentation unit 14 displays the causal loop diagram and the candidate measure to the manager of the organization (step B5).

After step B5 is executed, the processing by the information visualization apparatus 50 ends once. However, in the second example embodiment, steps B1 to B5 are executed again each time a set period of time passes, or each time a set amount of personal data is accumulated, for example. Accordingly, the manager of the organization can confirm the time-series variation of the causal loop diagram and the candidate measure.

### Effects of Second Example Embodiment

According to the second example embodiment, an effect of being able to present a measure which should be taken for an individual and the organization as a whole can be achieved, in addition to the effects of the first example embodiment. As a result, a manager of individuals and an organization can easily understand what they should do in order to increase motivation.

Program

It suffices for the program according to the second example embodiment to be a program that causes a computer to execute steps B1 to B5 illustrated in FIG. 16. The information visualization apparatus and the information visualization method according to the second example embodiment can be realized by installing the program in a computer and executing the program. In this case, a processor of the computer functions as the data obtainment unit 11, the coefficient calculation unit 12, the updating unit 13, the presentation unit 14, and the measure candidate formulation unit 17, and performs the processing.

Additionally, in the second example embodiment, the personal data storage unit 15 and the causal loop diagram storage unit 16 can be realized by storing data files corresponding to those units in a storage device, such as a hard disk, provided in the computer.

The program according to the second example embodiment may be executed by a computer system constructed from a plurality of computers. In this case, for example, each computer may function as one of the data obtainment unit 11, the coefficient calculation unit 12, the updating unit 13, the presentation unit 14, and the measure candidate formulation unit 17. The personal data storage unit 15 and the causal loop diagram storage unit 16 may be constructed in a different computer from the computer which executes the program according to the second example embodiment.

Physical Configuration

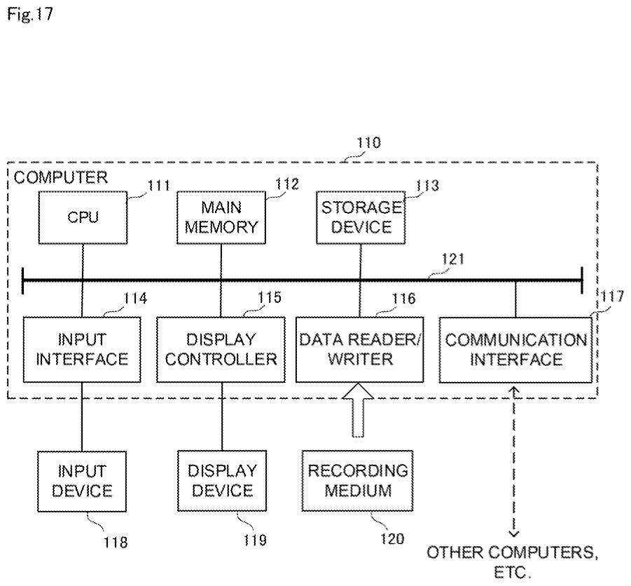

A computer that realizes the information visualization apparatus by executing the program according to the first and second example embodiments will be described with reference to FIG. 17. FIG. 17 is a block diagram illustrating an example of a computer that implements the information visualization apparatus according to an example embodiment of the invention.

As illustrated in FIG. 17, a computer 110 includes a CPU (Central Processing Unit) 111, main memory 112, a storage device 113, an input interface 114, a display controller 115, a data reader/writer 116, and a communication interface 117. These units are connected by a bus 121 so as to be capable of data communication with each other. Note that in addition to, or instead of, the CPU 111, the computer 110 may include a GPU (Graphics Processing Unit) or a FPGA (Field-Programmable Gate Array).

The CPU 111 loads the program (code) according to the present example embodiment, which is stored in the storage device 113, into the main memory 112, and executes the program according to a prescribed sequence, thereby carrying out various types of operations. The main memory 112 is typically a volatile storage device such as DRAM (Dynamic Random Access Memory) or the like. The program according to the present example embodiment is stored in a computer-readable recording medium 120 and provided in such a state. Note that the program according to the present example embodiment may be distributed over the Internet, which is connected via the communication interface 117.

In addition to a hard disk drive, a semiconductor storage device such as Flash memory or the like can be given as a specific example of the storage device 113. The input interface 114 facilitates data transfer between the CPU 111 and an input device 118 such as a keyboard and a mouse. The display controller 115 can be connected to a display device 119, and controls displays made in the display device 119.

The data reader/writer 116 facilitates data transfer between the CPU 111 and the recording medium 120, reads out programs from the recording medium 120, and writes results of processing performed by the computer 110 into the recording medium 120. The communication interface 117 facilitates data exchange between the CPU 111 and other computers.

A generic semiconductor storage device such as CF (Compact Flash (registered trademark)), SD (Secure Digital), or the like, a magnetic recording medium such as a flexible disk or the like, an optical recording medium such as a CD-ROM (Compact Disk Read Only Memory) or the like, and so on can be given as specific examples of the recording medium 120.

Note that the information visualization apparatus according to the present example embodiment can also be realized using hardware corresponding to the respective units, instead of a computer in which a program is installed. Furthermore, the information visualization apparatus may be partially realized by a program, with the remaining parts realized by hardware.

All or parts of the above-described example embodiments can be expressed as Supplementary Note 1 to Supplementary Note 18, described hereinafter, but is not intended to be limited to the following descriptions.

Supplementary Note 1

An information visualization apparatus comprising:

a data obtainment unit configured to obtain, as data, at least one of a response to a questionnaire administered to individuals belonging to an organization, or biometric information collected from the individuals;

a coefficient calculation unit configured to calculate a coefficient indicating correlation among nodes on the basis of the data obtained, in a causal loop diagram in which pre-registered items are nodes and relationships among the nodes are indicated by arrows;

an updating unit configured to update the causal loop diagram on the basis of the coefficient calculated; and

a presenting unit configured to present the causal loop diagram.

Supplementary Note 2

The information visualization apparatus according to Supplementary Note 1,

wherein the updating unit updates the causal loop diagram by deleting the arrow between nodes where a value of the coefficient is less than a threshold value and furthermore also deleting a node to which the arrow is no longer connected due to the deleting.

Supplementary Note 3

The information visualization apparatus according to Supplementary Note 1,

wherein when there is a node for which the arrow which is connected has been deleted, the updating unit calculates a coefficient indicating a correlation between the node for which the arrow which is connected has been deleted and another node, and updates the causal loop diagram by connecting the node for which the arrow which is connected has been deleted and the other node with the arrow on a condition that the coefficient calculated is at least a threshold.

Supplementary Note 4

The information visualization apparatus according to any one of Supplementary Notes 1 to 3, further comprising:

a measure candidate formulation unit configured to, when a specific node is designated in advance in the causal loop diagram, specify a loop structure constructed by the designated node, another node, and the arrow, and on the basis of the coefficient between nodes in the loop structure specified, specify a node that affects the designated node, and on the basis of an item of the specified node, formulate a candidate for a measure to be taken by the organization,

wherein the presenting unit further presents the candidate that has been formulated.

Supplementary Note 5

The information visualization apparatus according to any one of Supplementary Notes 1 to 4,

wherein the coefficient calculation unit calculates the coefficient for each of the individuals,

the updating unit updates the causal loop diagram for each of the individuals, and

the presenting unit presents the causal loop diagram for each of the individuals.

Supplementary Note 6

The information visualization apparatus according to any one of Supplementary Notes 1 to 4,

wherein the coefficient calculation unit calculates the coefficients for the organization as a whole using a collection of the data of each of the individuals, and

the updating unit makes the causal loop diagram a causal loop diagram for the organization as a whole by updating the causal loop diagram using the coefficients calculated for the organization as a whole.

Supplementary Note 7

An information visualization method comprising:

(a) a step of obtaining, as data, at least one of responses to a questionnaire administered to individuals belonging to an organization, or biometric information collected from the individuals;

(b) a step of calculating a coefficient indicating correlation among nodes on the basis of the data obtained, in a causal loop diagram in which pre-registered items are nodes and relationships among the nodes are indicated by arrows;

(c) a step of updating the causal loop diagram on the basis of the coefficient calculated; and

(d) a step of presenting the causal loop diagram.

Supplementary Note 8

The information visualization method according to Supplementary Note 7,

wherein in the (c) step, the causal loop diagram is updated by deleting the arrow between nodes where a value of the coefficient is less than a threshold value and furthermore also deleting a node to which the arrow is no longer connected due to the deleting.

Supplementary Note 9

The information visualization method according to Supplementary Note 7,

wherein in the (c) step, when there is a node for which the arrow which is connected has been deleted, a coefficient indicating a correlation between the node for which the arrow which is connected has been deleted and another node is calculated, and the causal loop diagram is updated by connecting the node for which the arrow which is connected has been deleted and the other node with the arrow on a condition that the coefficient calculated is at least a threshold.

Supplementary Note 10

The information visualization method according to any one of Supplementary Notes 7 to 9, further comprising:

(e) a step of, when a specific node is designated in advance in the causal loop diagram, specifying a loop structure constructed by the designated node, another node, and the arrow, and on the basis of the coefficient between nodes in the loop structure specified, specifying a node that affects the designated node, and on the basis of an item of the specified node, formulating a candidate for a measure to be taken by the organization; and

(f) a step of presenting the candidate that has been formulated.

Supplementary Note 11

The information visualization method according to any one of Supplementary Notes 7 to 10,

wherein in the (b) step, the coefficient is calculated for each of the individuals,

in the (c) step, the causal loop diagram is updated for each of the individuals, and

in the (d) step, the causal loop diagram is presented for each of the individuals.

Supplementary Note 12

The information visualization method according to any one of Supplementary Notes 7 to 10,

wherein in the (b) step, the coefficients for the organization as a whole are calculated using a collection of the data of each of the individuals, and

in the (c) step, the causal loop diagram is made a causal loop diagram for the organization as a whole by updating the causal loop diagram using the coefficients calculated for the organization as a whole.

Supplementary Note 13

A computer-readable recording medium storing a program including commands causing a computer to execute:

(a) a step of obtaining, as data, at least one of responses to a questionnaire administered to individuals belonging to an organization, or biometric information collected from the individuals;

(b) a step of calculating a coefficient indicating correlation among nodes on the basis of the data obtained, in a causal loop diagram in which pre-registered items are nodes and relationships among the nodes are indicated by arrows;

(c) a step of updating the causal loop diagram on the basis of the coefficient calculated; and

(d) a step of presenting the causal loop diagram.

Supplementary Note 14

The computer-readable recording medium according to Supplementary Note 13,

wherein in the (c) step, the causal loop diagram is updated by deleting the arrow between nodes where a value of the coefficient is less than a threshold value and furthermore also deleting a node to which the arrow is no longer connected due to the deleting.

Supplementary Note 15

The computer-readable recording medium according to Supplementary Note 13,

wherein in the (c) step, when there is a node for which the arrow which is connected has been deleted, a coefficient indicating a correlation between the node for which the arrow which is connected has been deleted and another node is calculated, and the causal loop diagram is updated by connecting the node for which the arrow which is connected has been deleted and the other node with the arrow on a condition that the coefficient calculated is at least a threshold.

Supplementary Note 16

The computer-readable recording medium according to any one of Supplementary Notes 13 to 15, the program further including commands causing the computer to execute:

(e) a step of, when a specific node is designated in advance in the causal loop diagram, specifying a loop structure constructed by the designated node, another node, and the arrow, and on the basis of the coefficient between nodes in the loop structure specified, specifying a node that affects the designated node, and on the basis of an item of the specified node, formulating a candidate for a measure to be taken by the organization; and

(f) a step of presenting the candidate that has been formulated.

Supplementary Note 17

The computer-readable recording medium according to any one of Supplementary Notes 13 to 16,

wherein in the (b) step, the coefficient is calculated for each of the individuals,

in the (c) step, the causal loop diagram is updated for each of the individuals, and

in the (d) step, the causal loop diagram is presented for each of the individuals.

Supplementary Note 18

The computer-readable recording medium according to any one of Supplementary Notes 13 to 16,

wherein in the (b) step, the coefficients for the organization as a whole are calculated using a collection of the data of each of the individuals, and

in the (c) step, the causal loop diagram is made a causal loop diagram for the organization as a whole by updating the causal loop diagram using the coefficients calculated for the organization as a whole.

While the invention has been described above with reference to example embodiments, the invention is not intended to be limited to the above example embodiments. Many variations can be made, by one of ordinary skill in the art, on the configuration and details of the invention without departing from the scope of the invention.

This application is based upon and claims the benefit of priority from Japanese application No. 2019-020142, filed on Feb. 6, 2019, the disclosure of which is incorporated herein in its entirety by reference.

### INDUSTRIAL APPLICABILITY

As described above, according to the invention, causal relationships among factors affecting motivation in individuals and an organization as a whole can be visualized. The invention is useful for managing organizations in companies and the like.

### REFERENCE SIGNS LIST

10 Information visualization apparatus (first example embodiment)
11 Data obtainment unit
12 Coefficient calculation unit
13 Updating unit
14 Presenting unit
15 Personal data storage unit
16 Causal loop diagram storage unit
17 Measure candidate formulation unit
20 Display device
30 Terminal device
40 Network
50 Information visualization apparatus (second example embodiment)
110 Computer
111 CPU
112 Main memory
113 Storage device
114 Input interface
115 Display controller
116 Data reader/writer
117 Communication interface
118 Input device
119 Display device
120 Recording medium
121 Bus

What is claimed is:

1. An information visualization apparatus comprising:
a data obtainment unit configured to obtain, as data, at least one of a response to a questionnaire administered to individuals belonging to an organization, or biometric information collected from the individuals;
a coefficient calculation unit configured to calculate a coefficient indicating correlation among nodes on the basis of the data obtained, in a causal loop diagram in which pre-registered items are nodes and relationships among the nodes are indicated by arrows;
an updating unit configured to update the causal loop diagram on the basis of the coefficient calculated; and
a presentation unit configured to present the causal loop diagram.

2. The information visualization apparatus according to claim 1,
wherein the updating unit updates the causal loop diagram by deleting the arrow between nodes where a value of the coefficient is less than a threshold value and furthermore also deleting a node to which the arrow is no longer connected due to the deleting.

3. The information visualization apparatus according to claim 1,
wherein when there is a node for which the arrow which is connected has been deleted, the updating unit calculates a coefficient indicating a correlation between the node for which the arrow which is connected has been deleted and another node, and updates the causal loop diagram by connecting the node for which the arrow which is connected has been deleted and the other node with the arrow on a condition that the coefficient calculated is at least a threshold.

4. The information visualization apparatus according to claim 1, further comprising:
a measure candidate formulation unit configured to, when a specific node is designated in advance in the causal loop diagram, specify a loop structure constructed by the designated node, another node, and the arrow, and on the basis of the coefficient between nodes in the loop structure specified, specifying a node that affects the designated node, and on the basis of an item of the specified node, formulating a candidate for a measure to be taken by the organization,
wherein the presentation unit further presents the candidate that has been formulated.

5. The information visualization apparatus according to claim 1,
wherein the coefficient calculation unit calculates the coefficient for each of the individuals,
the updating unit updates the causal loop diagram for each of the individuals, and
the presentation unit presents the causal loop diagram for each of the individuals.

6. The information visualization apparatus according to claim 1,
wherein the coefficient calculation unit calculates the coefficients for the organization as a whole using a collection of the data of each of the individuals, and
the updating unit makes the causal loop diagram a causal loop diagram for the organization as a whole by updating the causal loop diagram using the coefficients calculated for the organization as a whole.

7. An information visualization method comprising:
obtaining, as data, at least one of a response to a questionnaire administered to individuals belonging to an organization, or biometric information collected from the individuals;
calculating a coefficient indicating correlation among nodes on the basis of the data obtained, in a causal loop diagram in which pre-registered items are nodes and relationships among the nodes are indicated by arrows;
updating the causal loop diagram on the basis of the coefficient calculated; and
presenting the causal loop diagram.

8. The information visualization method according to claim 7,
wherein in the updating, the causal loop diagram is updated by deleting the arrow between nodes where a value of the coefficient is less than a threshold value and furthermore also deleting a node to which the arrow is no longer connected due to the deleting.

9. The information visualization method according to claim 7,
wherein in the updating, when there is a node for which the arrow which is connected has been deleted, a coefficient indicating a correlation between the node for which the arrow which is connected has been deleted and another node is calculated, and the causal loop diagram is updated by connecting the node for which the arrow which is connected has been deleted and the other node with the arrow on a condition that the coefficient calculated is at least a threshold.

10. The information visualization method according to claim 7, further comprising:
when a specific node is designated in advance in the causal loop diagram, specifying a loop structure constructed by the designated node, another node, and the arrow, and on the basis of the coefficient between nodes in the loop structure specified, specifying a node that affects the designated node, and on the basis of an item of the specified node, formulating a candidate for a measure to be taken by the organization; and
presenting the candidate that has been formulated.

11. The information visualization method according to claim 7,
wherein in the (b), the coefficient is calculated for each of the individuals,
in the updating, the causal loop diagram is updated for each of the individuals, and
in the presenting, the causal loop diagram is presented for each of the individuals.

12. The information visualization method according to claim 7,
wherein in the calculating, the coefficients for the organization as a whole are calculated using a collection of the data of each of the individuals, and
in the updating, the causal loop diagram is made a causal loop diagram for the organization as a whole by updating the causal loop diagram using the coefficients calculated for the organization as a whole.

13. A non-transitory computer-readable recording medium storing a program including commands causing a computer to execute:
obtaining, as data, at least one of responses to a questionnaire administered to individuals belonging to an organization, or biometric information collected from the individuals;
calculating a coefficient indicating correlation among nodes on the basis of the data obtained, in a causal loop diagram in which pre-registered items are nodes and relationships among the nodes are indicated by arrows;
updating the causal loop diagram on the basis of the coefficient calculated; and
presenting the causal loop diagram.

14. The non-transitory computer-readable recording medium according to claim 13,
wherein in the updating, the causal loop diagram is updated by deleting the arrow between nodes where a value of the coefficient is less than a threshold value and furthermore also deleting a node to which the arrow is no longer connected due to the deleting.

15. The non-transitory computer-readable recording medium according to claim 13,
wherein in the updating, when there is a node for which the arrow which is connected has been deleted, a coefficient indicating a correlation between the node for which the arrow which is connected has been deleted and another node is calculated, and the causal loop diagram is updated by connecting the node for which the arrow which is connected has been deleted and the other node with the arrow on a condition that the coefficient calculated is at least a threshold.

16. The non-transitory computer-readable recording medium according to claim 13, the program further including commands causing the computer to execute:
when a specific node is designated in advance in the causal loop diagram, specifying a loop structure constructed by the designated node, another node, and the arrow, and on the basis of the coefficient between nodes in the loop structure specified, specifying a node that affects the designated node, and on the basis of an item of the specified node, formulating a candidate for a measure to be taken by the organization; and
presenting the candidate that has been formulated.

17. The non-transitory computer-readable recording medium according to claim 13,
wherein in the calculating, the coefficient is calculated for each of the individuals,
in the updating, the causal loop diagram is updated for each of the individuals, and
in the presenting, the causal loop diagram is presented for each of the individuals.

18. The non-transitory computer-readable recording medium according to claim 13,
wherein in the calculating, the coefficients for the organization as a whole are calculated using a collection of the data of each of the individuals, and
in the updating, the causal loop diagram is made a causal loop diagram for the organization as a whole by updating the causal loop diagram using the coefficients calculated for the organization as a whole.
